(19) United States
(12) Patent Application Publication
(10) Pub. No.: US 2025/0376541 A1
(43) Pub. Date: Dec. 11, 2025

(54) PROCESS FOR THE EXTRACTION AND ISOLATION OF SPECIFIC TYPES OF STARCHES AND DERIVATIVES THEREOF FROM LEGUMES

(71) Applicant: INDUSTRI ROLLI ALIMENTARI SPA, Roseto Degli Abruzzi (IT)

(72) Inventors: Gian Paolo ROLLI, Felino, Frazione S. Michele Di Tiorre (IT); Lorenzo CERRETANI, Montesilvano (IT)

(21) Appl. No.: 18/876,989

(22) PCT Filed: Jun. 27, 2022
(86) PCT No.: PCT/IT2022/000032

§ 371 Date: Dec. 19, 2024

(51) Int. Cl. C08B 30/04; C08B 30/12

(52) U.S. Cl. CPC C08B 30/04; C08B 30/12

(57) ABSTRACT

A process for the extraction and isolation of starches and derivatives thereof from legumes, the process having a first step of physical separation of a fraction with high content of proteins and fibers and a fraction with high content of starches on a product constituted by ground legumes. The process followed by a second step of mixing of the fraction with high content of starches with water, a third step of filtration by apparatuses such as centrifugal screens, centrifugal separators, hydrocyclones and combinations thereof, and a fourth step of drying until a condition of maximum humidity of 20% by weight is reached, obtaining an intermediate product with high content of starches.

### CROSS-REFERENCE TO RELATED APPLICATIONS

This application is a 35 U.S.C. § 371 National Stage patent application of PCT/IT2022/000032 filed 27 Jun. 2022, the disclosure of which is incorporated herein by reference in its entirety.

### TECHNICAL FIELD

The present disclosure relates to a process for the extraction and isolation of starches and derivatives thereof from legumes. All types of legume can be subjected to the process according to the disclosure, and in particular peas (of all varieties and types), beans (of all varieties and types), peanuts (of all varieties and types), chickpeas (of all varieties and types), lupins (of all varieties and types), soybean (of all varieties and types), snap peas (of all varieties and types), green beans (of all varieties and types), fava beans (of all varieties and types), carobs (of all varieties and types), lentils (of all varieties and types), grass peas (of all varieties and types), pigeon peas (of all varieties and types) and the like are suitable.

### BACKGROUND

Starches are one of the main forms of food carbohydrates.

Starchy foods are derived from vegetable sources. In vegetables, starches are present in the form of granules. The size and shape of the starch granules vary among plant species and even among cultivars within the same species. Chemically, starches are polysaccharides, i.e., they are composed of a certain number of monosaccharides or molecules of sugar (glucose) bonded together with α1-4 and/or α1-6 bonds. There are two main structural types of starch: amylose, which is an α1-4 linear molecule and typically constitutes 15-20% of starch, and amylopectin, which is a larger ramified molecule with α1-4 and α1-6 bonds and is a component of most starch (BNF 1990). Two crystalline structures of starch (a type ‘A’ and a type ‘B’) have been identified which contain different proportions of amylopectin. Type A starches are found in cereals, while type B starches are found in tubers. A third type, known as “type C”, appears to be a mixture of both forms A and B and is found in legumes (Topping & Clifton 2001). In general, digestible starches are broken down (hydrolyzed) by the enzymes α-amylase, glucoamylase and sucrase-isomaltase in the small intestine, in order to produce free glucose which is then absorbed.

In 1982, during the development of an in vitro test for nonamylaceous polysaccharides (a kind of dietary fiber), Englyst et al. of the University of Cambridge discovered that some starch remained after enzyme hydrolysis. Follow-up studies with healthy subjects confirmed the presence of similar starches, which resisted digestion in the stomach and in the small intestine. The term “resistant starch” (RS) was thus coined and used to describe these starches (Englyst et al. 1982).

The resistance of starch to digestion is influenced by the nature of the association between the polymers of starch, with higher amylose levels in starch which are associated with slower digestibility rates. Both type B and type C starches appear to be more resistant to digestion. Resistant starch (RS) constitutes approximately 10% of dietary starch; it is a nutritional molecule which, owing to its impact on intestinal-metabolic balance, falls into the category of dietary fiber and/or of functional components: molecules that are interesting due to their content low in calories.

The definition “retrograded starches” refers to some structural forms of resistant starch. Retrogradation occurs when starch is cooked in water beyond its gelatinization temperature and then cooled. After heating with excess water and at sufficiently high temperatures, the crystalline regions of starch “dissolve”. The starch granules gelatinize and the starch is subsequently more easily digestible. However, these starch gels are unstable and after cooling they reform the crystals that are resistant to hydrolysis by amylases (i.e., they are resistant to digestion). Slow cooling of gelatinized starch favors type A crystallization, while slow cooling in excess water favors type B crystallization. This process is known as retrogradation (Topping & Clifton 2001). In general, starches rich in amylose are naturally more resistant to digestion and are also more susceptible to retrogradation.

The consumption of soluble fibers can provide cardiocirculatory benefits, influencing the metabolism of both lipids and glucose. Resistant starch (RS) shares some properties with soluble dietary fibers, in that it is scarcely digested in the small intestine and is extensively digested and metabolized (fermented) in the colon. However, differently from soluble fiber, the fraction of resistant starch that reaches the colon is not viscous, can be incorporated easily in most starchy foods in the diet, and is considered more palatable (Demigné et al. 2001). A significant number of studies has examined the influence of resistant starch on lipid and glucose metabolism (including the glycemic index), on energy expenditure and on macronutrient oxidation.

In this regard, it is noted that the glycemic index (GI) is a physiological concept used to classify carbohydrate-containing foods. It is closely tied to the expression “glycemic response”. Both refer to the capacity of a particular food to increase glucose concentrations in postprandial blood. The glycemic index is measured as the incremental area below the glycemia curve after consuming 50 g of carbohydrates made available by the consumption of a tested food, divided by the area subtended by the curve, after eating a similar quantity of carbohydrates available in a control food, generally white bread or glucose (Ludwig & Eckel 2002).

Foods with a high glycemic index value release glucose into the bloodstream rapidly (i.e., they produce a rapid glycemic response), while foods with a low glycemic index value release glucose more slowly into the bloodstream and lead to a better glycemic and insulinemic response. These foods can also modulate the oxidation of macronutrients (fats). Recently there has been an increase in public and commercial interest for the concept of glycemic index and its possible inclusion on food labels, both as an aid for diabetes management and for indicating potential foods that can aid in body weight loss and management (McKevith 2004). It is known that dietary fibers can contribute to an improved (i.e., slower and more controlled) glycemic response and in general foods rich in fibers are given a lower glycemic index value. Interest is now increasing in the assignment of glycemic index values to foods rich in resistant starches. However, it should be noted that for foods enriched with truly resistant starches, a reduced glycemic response may derive simply from the lack of available digestible starch rather than from specific physiological effects per se and that any easily digestible starch present in foods would be absorbed normally (Hoebler et al. 1999; Jenkins et al. 2002). However, there will be the physiological effect, as a result, of the lowering of the content of digestible starch by replacing it with resistant starch.

The glycemic index refers to the nature of the carbohydrates in a food. However, people consume meals (mixtures of foods) and generally foods containing carbohydrates, which are consumed together with foods containing proteins and/or fats. Moreover, the total content of carbohydrates (quantity) varies among foods. To take this into account, the concept of glycemic load has been developed which considers both the content of carbohydrates per portion of a food and its glycemic index value, i.e., the quantity and nature of the carbohydrates that are present. By using the glycemic load it is easier to take into account a range of foods and also portion sizes. It is possible to lower the glycemic load by replacing the content of carbohydrates with proteins, fats or other carbohydrates with a low glycemic index. Since resistant starch has a low glycemic response, adding it as an ingredient to foods contributes to reducing the value of the total glycemic load of the food (in particular if it is replacing promptly absorbed forms of existing carbohydrates).

Since the concepts of glycemic index and glycemic load are becoming increasingly public domain, it is likely that resistant starches will become increasingly attractive ingredients for many food manufacturers (in particular manufacturers of bread and confectionery or similar products which traditionally can have a higher glycemic index value).

Moreover, it has been reported that resistant starch improves ileal absorption of a certain number of minerals in rats and humans.

More recently, it has been reported that resistant starch influences the immune function, in particular the production of a certain number of pro- inflammatory cytokines (e.g., tumor necrosis factor alpha) and the expression of a certain number of receptors on T and B lymphocytes and on macrophages which are necessary for the start of immune responses. If resistant starch can modulate the immune function beneficially, it might give real benefits to patients with inflammatory bowel disease.

These nascent needs are not met by the current production of intermediate dietary products, since methods for extracting starches from legumes that allow to select the respective components with reduced glycemic index or generically suitable to be used for the production of food with low glycemic load are not known.

### SUMMARY

The aim of the present disclosure is to solve the problems described above, providing a process for the extraction and isolation of starches and derivatives thereof from legumes that allows a fractionation of the various components of starch in accordance with the growing needs of the food industry.

Within this aim, the disclosure provides a process for the extraction and isolation of starches and derivatives thereof from legumes that allows a fractionation of the various components of starch to provide food supplements.

Another feature of the disclosure is to provide a process for the extraction and isolation of starches and derivatives thereof from legumes that allows to convert a wide range of starches into resistant starches.

Another feature of the disclosure is to provide a process for the extraction and isolation of starches and derivatives thereof from legumes that is suitable to isolate an intermediate product intended for the production of biopolymers.

Another advantage of the disclosure is to provide a process for the extraction and isolation of starches and derivatives thereof from legumes that can be inserted in a broader process for the fractionation of the macronutrients of the legumes being processed.

The present disclosure provides a process for the extraction and isolation of starches and derivatives thereof from legumes that has low costs, is relatively simple to provide in practice and is of assured application.

This aim and these advantages, as well as others which will become better apparent hereinafter, are achieved by providing a process for the extraction and isolation of starches and derivatives thereof from legumes which comprises a first step of physical separation of a fraction with high content of protein and fibers and a fraction with high content of starches on a product P constituted by ground legumes, characterized in that comprises
a second step of mixing of said fraction with high content of starches with water;
a third step of filtration by means of apparatuses such as centrifugal screens, centrifugal separators, hydrocyclones and combinations thereof;
a fourth step of drying until a condition of maximum humidity of 20% by weight is reached, obtaining an intermediate product with high content of starches.

### BRIEF DESCRIPTION OF THE DRAWING

Further characteristics and advantages of the disclosure will become better apparent from the description of a preferred but not exclusive embodiment of the process for the extraction and isolation of starches and derivatives thereof from legumes, illustrated by way of non-limiting example in the accompanying drawings, wherein:

FIG. 1 is a diagram of the process for the extraction and isolation of starches and derivatives thereof from legumes according to the disclosure.

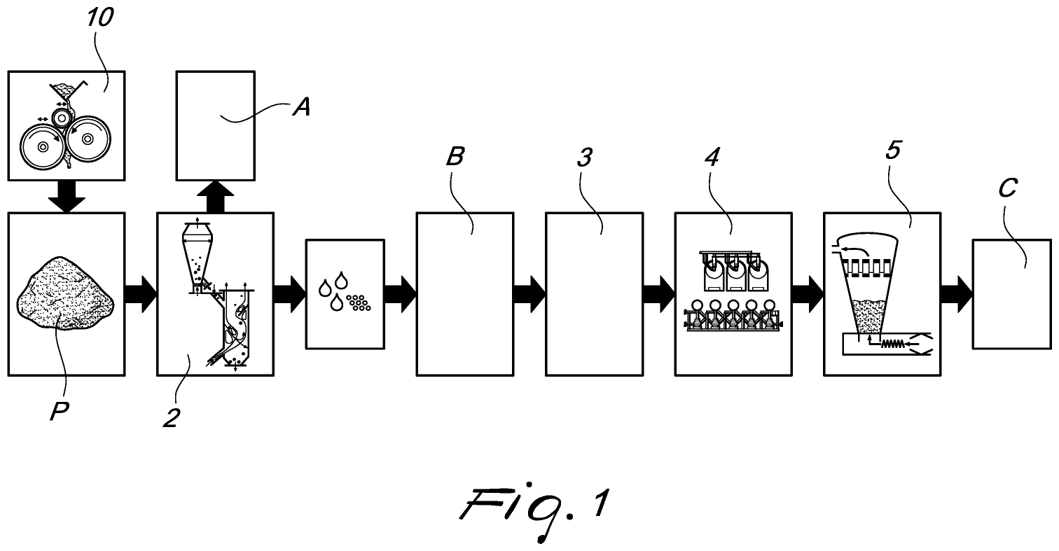

### DETAILED DESCRIPTION OF THE DRAWING

With reference to the figure, the reference numeral 1 generally designates a process for the extraction and isolation of starches and derivatives thereof from legumes.

The process 1 comprises a first step 2 of physical separation of a fraction with high content of proteins and fibers A and a fraction B with high content of starches: this separation step is performed starting from a product P constituted by ground legumes.

The process 1 comprises furthermore a second step 3 of mixing of the fraction B with high content of starches with water.

During a subsequent third step 4, the fraction B mixed with water is filtered by means of apparatuses such as centrifugal screens, centrifugal separators, hydrocyclones and combinations thereof.

The process 1 comprises advantageously a fourth step 5 of drying of the material filtered in the third step 4, until a condition of maximum humidity of 20% by weight (preferably not higher than 13%) is reached, obtaining an intermediate product C with high content of starches.

With particular reference to one embodiment of unquestionable interest in practice and in application, the process 1 according to the disclosure can conveniently comprise a fifth step of converting the intermediate product C with high content of starches (obtained at the end of the fourth step 5) into modified starches.

It is understood that resistant starches, retrograded starches, deramified starches and degraded starches fall within the definition of modified starches.

Such fifth step of converting the intermediate product C with high content of starches into modified starches can advantageously have a sub-step of physical treatment during which said intermediate product C is subjected to at least one stress chosen from ultrasound, a thermal stress, and a combination thereof. These physical treatments have the purpose of increasing the quantity of resistant starches in the intermediate product C, of favoring the retrogradation of the starches that are present therein, and of favoring the type B crystallization of the starches that are present therein.

In particular, the ultrasound stress provides for a solubilization of the intermediate product C with high content of starches in water to saturation. It is then possible to proceed advantageously with the mixing and treatment of said solubilized mixture with an ultrasound probe, providing its immersion to a depth comprised between 20 mm and 200 mm (preferably between 80 mm and 100 mm) from the surface, providing a constant frequency comprised between 20 and 25 kHz (preferably 22 kHz) for this ultrasound.

This ultrasound stress is emitted with a power range comprised between 200 W and 460 W (in particular, in the case of application with ultrasound amplitude equal to 40%, the power shall be comprised between 200 W and 250 W, while in the case of application with ultrasound amplitude equal to 70% the power shall be comprised between 400 W and 460 W) for a time comprised between 1 hour and 5 hours (preferably approximately 3 hours in the case of 40% amplitude and approximately 2 hours in the case of 70% amplitude). In any case, the duration of each pulse shall be approximately 5 seconds, followed by inactivity intervals lasting approximately 25 seconds.

Within the scope of the embodiment of the process 1 according to the disclosure described above, it is specified that a thermal pre-gelatinization stress might usefully include the solubilization of the intermediate product C with high content of starches in water performed to saturation, followed by heating to a temperature comprised between 50° C. and 60° C. (preferably 58° C.) for 5 minutes, and a subsequent heating to a temperature of approximately 90° C. for a time interval comprised between 10 minutes and 15 minutes.

This thermal pre-gelatinization stress might furthermore include the solubilization of the intermediate product C with high content of starches in water to saturation, followed by a treatment in an autoclave at a temperature comprised between 100° C. and 150° C. (preferably 121° C.), at a pressure comprised between 0.01 MPa and 1 MPa (preferably 0.1 MPa) for a time comprised between 30 minutes and 3 hours (preferably 20 minutes).

It is appropriate to point out that the process 1 according to the disclosure might also validly comprise a sixth step of converting the intermediate dietary product C with high content of starches into a compound containing a high percentage of modified starches. This sixth step provides for at least one sub-step of enzyme treatment with enzymes of the class of hydrolases at a temperature comprised between 55° C. and 60° C. (preferably 58° C.) for a time interval comprised between 30 minutes and 20 hours, for the deramification and degradation of the starches.

Such sub-step of enzyme treatment may positively comprise a first treatment with an enzyme of the type of α-amylase at a temperature comprised between 55° C. and 60° C. (preferably 58° C.) for a time interval comprised between 30 minutes and 4 hours (preferably between 1 hour and 2 hours) for degradation of the starches, and a second treatment with an enzyme of the type of pullulanase at a temperature comprised between 55° C. and 60° C. (preferably 58° C.) for a time interval comprised between 5 hours and 20 hours (preferably between 10 hours and 14 hours), for the deramification of the starches.

It is noted, moreover, that the first step 2 of physical separation of a fraction A with high content of proteins and fibers and a fraction B with high content of starches can usefully comprise at least one sub-step chosen from air classification for the separation of components of the initial product P (i.e., ground legumes) on the basis of a combination of weight, shape and density, and a micronization of the granules that constitute the initial product, to a condition in which at least 50% of the product has a predominant dimension that is substantially smaller than 25 microns.

Moreover, it is specified that the process 1 according to the disclosure may furthermore comprise an additional and convenient step of legume preparation, prior to the first step 2, in which at least one treatment chosen from the following is performed:
quali-quantitative analysis by means of at least one method chosen from gas chromatography and liquid chromatography, both interfaced with mass spectrometry, for the identification and quantification of the molecules of pesticides and/or derivatives thereof and of mycotoxins;
quali-quantitative analysis by means of inductively coupled plasma with mass spectrometry for the identification and quantification of heavy metals;
storage of the legumes in a controlled atmosphere without adding preservatives of chemical origin;
monitoring, of a type chosen from continuous and at regular intervals, of the mycotoxin content;
grinding (10) of the physical type to obtain said product.

These treatments can furthermore include the continuous (at least quarterly) updating of the databases of molecules and methods for the analysis of molecules and new molecules of interest (pesticides and mycotoxins), the use of accredited/accreditable analytical methods, and the verification of the absence of molecules of interest performed according to a so-called “three-step” criterion. The “three-step criterion” provides for: execution of the analyses during pre-harvesting on the fresh vegetable matrices, repetition of the analysis during the transfer of the fresh vegetable matrices, and final verification on the finished products.

Finally, it is specified that the process according to the disclosure can comprise efficiently, prior to the legume preparation step, an agronomic step, which in turn can comprise at least one action chosen from:
analysis of the soils in order to identify the best conditions of accumulation of mineral elements (microelements and macroelements) of nutritional interest;
choice of the soils suitable to achieve the expected production of the vegetable matrix, without using or in any case reducing to a minimum the use of pesticides (for example by studying the historical data collected in documents such as farmbooks);
choice of varieties of seeds that are not genetically modified;
choice of the varieties of seeds most suitable for the area identified for the crop and for the growing period (for example by studying the historical data on experimental or outdoor crop of the chosen variety);
choice of the varieties of seeds most suitable to achieve a higher content of amylose;
execution of seed germinability tests on the specific batches of seeds, which includes verifying the aptness of the seed, if placed in suitable external conditions of temperature, humidity and lighting, to germinate and produce a new plant;
sowing distributed according to precision farming criteria (so-called “variable sowing”) following a mapping of the soils via satellite monitoring and/or drones and soil analyses;
verification and control of the crop during the vegetative/growing cycle on the part of specialized operators and identification of possible allowed pesticides by selecting them among those with low residuality and low preharvest interval (this activity can be performed during the vegetative/growing cycle by one's own technicians and sharing with the operator of the farm of a list of possible allowed pesticides, also providing for the use of DSS—Decision Support Systems);
verification of growth during the vegetative/growing cycle according to precision farming criteria via satellite monitoring and/or drones to identify within the fields the only regions that would require the application of pesticides;
control, by means of precision farming criteria, of factors that induce the forming of secondary metabolites, produced by plants in stress situations, which are normally present in vegetables and can also have dual nutritional/anti-nutritional effects, such as phytates, saponins, or polyphenols, tannins and the like;
supply of biostimulants, which includes substances having a specific action with a natural base and active on the primary and secondary metabolism of plants, in order to facilitate bioavailability and absorption of molecules of nutritional interest of the type chosen from minerals, macronutrients, micronutrients and the like (among these possible molecules of nutritional interest, mention is made for example of minerals such as iron, zinc, calcium, magnesium, selenium and iodine);
sampling prior to harvesting for analysis and verification of a concentration of pesticides lower than 0.005 ppm;
verification, prior to harvesting, of the humidity of the dried matrices in the field and of the content in mycotoxins;
harvesting only in the case of presence of pesticides below the threshold of 0.005 ppm and in case of substantial absence of mycotoxins.

The process 1 according to the disclosure described so far allows to enhance and improve flours rich in starches of legumes for the production of
1. native food starches characterized by resistant starch nutritional properties (concentration of the amylose content);
2. native starches characterized by the high presence of slowly digestible starches (increase in the amylose content);
3. modified food starches characterized by resistant starch nutritional properties (concentration of the amylose content and/or retrogradation);
4. modified starches characterized by the high presence of slowly digestible starches (increase in the amylose content and/or retrogradation);
5. starches characterized by a higher content of mineral macroelements and mineral microelements (for example calcium, copper, iron, magnesium, zinc, selenium and iodine) with respect to other starches used as gluten free ingredients.

The process 1 ensures that the extracted and treated starch has:
a) absence of gluten;
b) absence of genetically modified organisms (GMO);
c) absence of residues of pesticides (more precisely, presence lower than 0.01 mg/kg, or parts per million, and, where allowed by the quantification limit of the individual molecule, lower than 0.005 mg/kg, or parts per million);
d) presence and bioavailability of microelements of importance nutritionally and naturally present in vegetable matrices (for example minerals such as iron, zinc, calcium and magnesium).

Moreover, it is not excluded that the process 1 according to the disclosure might, by means of the cited interventions of the agronomic type (prior to harvesting), allow the final product to ensure the presence and the bioavailability of microelements of importance nutritionally and naturally increased in the vegetable matrices (for example minerals such as selenium and/or zinc and/or iodine).

By means of the process 1 according to the disclosure it is possible to obtain flour of legumes (i.e., yellow pea) of a hypoproteic type or with a high content of starch, which can have the following possible commercial uses:
i. marketing to end customers (in 1-kg or 500-g bags wholesale) for use in specific domestic preparations (for example mushy peas, pea farinata, savory pancakes, etcetera) as a thickening ingredient for sauces, soups, purees, creams and puddings, recipes for gluten free preparations;
ii. marketing to industrial customers of the food sector, which can use the flour as an ingredient in numerous preparations such as bakery products, sauces, soups, purees, creams, puddings and/or gluten free preparations;
iii. marketing to industrial customers of the feed sector, which can use the flour as an ingredient for the preparation of animal feeds.

It is possible to provide, by means of the process 1 according to the disclosure, a native starch of legumes (i.e., yellow pea) which can have the following commercial uses:
I. marketing to customers (in 1-kg or 500-gram bags for retail) for use in domestic preparations as an alternative to corn starch or other food starches;
II. marketing to industrial customers of the food sector, which can use the flour as an ingredient in numerous preparations;
III. marketing to industrial customers of bioplastics.

It is possible to provide, by means of the process 1 according to the disclosure, a native starch of legumes (i.e., yellow pea) which is naturally biofortified in microelements and can have the following commercial uses:
marketing to end customers (in 1-kg or 500-g bags for retail) for use in domestic preparations as an alternative to corn starch or other food starches. In particular of interest to consumers who are mindful of the content of microelements for nutritional and health-related purposes. For example, the zinc content is of interest for the antiaging function; the iodine content is of interest for the good functioning of the body (particularly the thyroid); the selenium content is of interest for the good functioning of the body. Moreover, the mineral content is of interest for people who practice sports;
marketing to industrial customers of the food sector, which can use the flour as an ingredient in numerous preparations.

It is possible to provide, by means of the process 1 according to the disclosure, a modified starch of legumes (i.e., yellow pea) characterized by resistant starch properties, which can have the following commercial uses:
marketing to end customers (in 1-kg or 500-g bags for retail) for use in domestic preparations as an alternative to corn starch or other food starches. In particular, of interest to consumers who are mindful of low-calorie input, functionality (similar to fibers) and to some categories of consumers, such as diabetics;
marketing to industrial customers of the food sector, which can use the flour as an ingredient in numerous preparations.

It is possible to provide, by means of the process 1 according to the disclosure, a modified starch of legumes (i.e., yellow pea) that is naturally biofortified in microelements and characterized by resistant starch properties and can have the following commercial uses:
marketing to end customers with the advantages according to the previous two items;
marketing to industrial customers of the food sector with the advantages according to the two preceding items.

The possibility to provide these indications and the particular nutritional specificities on the packaging constitutes an important commercial vehicle for increasing the interest of customers in each specific finished product.

Purified starches in powder form and legume syrups can have several applications in the food sector. In particular, they might be used as intermediate products in various types of food industries and for the processing of “healthy foods” characterized by a high presence of resistant starch. Healthy foods that use the starches indicated above might be provided in the following sectors of the food industry: confectionery, bakery products (bread, pizzas, biscuits, etc.), gluten-free pasta, products for diabetics.

These purified starches in powder form and these legume syrups might be marketed directly as sweeteners (of the “plant-based” type) obtained from peas or other legumes.

Finally, said purified starches and said syrups might be marketed directly as starches rich in microelements for domestic use (also in food supplementation).

The starches in powder form can also be used for the production of biopolymers. In this case it would be possible to produce biodegradable panels which are alternative for example to expanded polystyrene panels. The starches to be used for the production of these materials shall be subjected to specific chemical pre-treatments which precede separation and drying, and then will be mixed with other biodegradable ingredients. Likewise, legume starches might be used for the production of biodegradable packaging materials (for example, shock protections which replace foam peanuts).

Purified starches in powder form can also be used in the pharmaceutical sector; they may be used as excipients, in the provision of disintegrating tablets and capsules, as dilution agents for tablets and capsules, and as binding agents.

Advantageously, the present disclosure solves the problems described above, proposing the process 1 for the extraction and isolation of starches and derivatives thereof from legumes according to the disclosure that allows a fractionation of the various components of the starch in accordance with the growing requirements of the food industry.

Conveniently, the process 1 according to the disclosure allows a fractionation of the various components of starch in order to provide food supplements.

Advantageously, the process 1 according to the disclosure allows to convert a broad range of starches into resistant starches.

Favorably, the process 1 according to the disclosure is suitable to isolate an intermediate product C which is designed for the production of biopolymers.

Positively, the process 1 according to the disclosure can be inserted in a broader process for the fractionation of the macronutrients of the legumes being processed (a method which shall allow to divide proteins, fibers and starches).

Validly, the process 1 according to the disclosure is relatively simple to provide in practice and low in cost: these characteristics render the process 1 according to the disclosure an innovation of assured application.

The disclosure thus conceived is susceptible of numerous modifications and variations, all of which are within the scope of the accompanying claims; all the details may furthermore be replaced with other technically equivalent elements.

In the examplary embodimenst shown, individual characteristics, given in relation to specific examples, may actually be interchanged with other different characteristics that exist in other exemplary embodiments.

In practice, the materials used, as well as the dimensions, may be any according to the requirements and the state of the art.

1-11. (canceled)

12. A process for the extraction and isolation of starches and derivatives thereof from legumes, comprising a first step of physical separation of a fraction with high content of proteins and fibers and a fraction with high content of starches on a product constituted by ground legumes, and further comprising:
a second step of mixing of said fraction with high content of starches with water;
a third step of filtration by means of apparatuses such as centrifugal screens, centrifugal separators, hydrocyclones and combinations thereof; and
a fourth step of drying until a condition of maximum humidity of 20% by weight is reached, obtaining an intermediate product with high content of starches.

13. The process according to claim 12, further comprising a fifth step of converting said intermediate product with high content of starches into modified starches, which provides for a sub-step of physical treatment of subjecting said intermediate product to at least one stress chosen from ultrasound, a thermal stress and a combination thereof, for an increase in said intermediate product of resistant starches, for the retrogradation of the starches and to favor type B crystallization of the starches.

14. The process according to claim 13, wherein said ultrasound stress includes the following steps:
solubilizating said intermediate product with high content of starches in water up to saturation, and
mixing and treating with ultrasound probe, with associated immersion of said probe to a depth comprised between 20 mm and 200 mm from the surface in the intermediate product solubilized in water at a constant frequency comprised between 20 and 25 kHz.

15. The process according to claim 14, wherein said ultrasound stress
